(19) United States
(12) Patent Application Publication
(10) Pub. No.: US 2007/0103394 A1
(43) Pub. Date: May 10, 2007

(54) Method of driving plasma display panel

(75) Inventors: Tae-Hyun Kim, Suwon-si (KR); Joo-Yul Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/589,209

(22) Filed: Oct. 30, 2006

(30) Foreign Application Priority Data
Nov. 7, 2005 (KR) 2005-106028

(51) Int. Cl. G09G 3/28

(52) U.S. Cl. 345/63

(57) ABSTRACT

A method of driving a high brightness and high contrast plasma display panel which does not generate an erroneous discharge in a sustain period due to a strong discharge in a reset period. The method includes initializing discharge cells defined in areas where a plurality of electrodes cross, in a reset period by applying falling pulses to first electrodes and a bias voltage to second parallel electrodes from when or anytime after the reset falling pulses are applied, and the second electrodes are floated or bias falling pulses are applied to the second electrodes during a predetermined period from when or anytime after the reset falling pulses are applied to when the reset period ends; addressing discharge cells selected to be turned on and off in an address period; and performing a sustain discharge in a sustain period in each discharge cell that is selected to be turned on.

### CROSS-REFERENCE TO RELATED APPLICATIONS

This application claims the benefit of Korean Application No. 2005-106028, filed Nov. 7, 2005, in the Korean Intellectual Property Office, the disclosure of which is incorporated herein in it entirety by reference.

### BACKGROUND OF THE INVENTION

1. Field of the Invention

Aspects of the present invention relate to a method of driving a plasma display panel, and more particularly, to a method of driving a plasma display panel having high brightness and high contrast which does not generate an erroneous discharge over a sustain period due to a strong discharge during a reset period.

2. Description of the Related Art

In plasma display devices, which have generally replaced conventional cathode ray tube (CRT) display devices, discharge gas fills a space between two substrates of a plasma display panel, wherein a plurality of electrodes are formed on each substrate, discharge voltages are applied to the electrodes, vacuum ultraviolet radiation is generated by discharge, and the vacuum ultraviolet radiation excites phosphor formed in a predetermined pattern, thereby displaying images.

FIG. 1 illustrates waveforms of a signal to drive a conventional plasma display panel. Referring to FIG. 1, in a reset period PR, a reset rising pulse that rises from a sustain discharge voltage Vs to a rising maximum voltage Vs+Vset and a reset falling pulse that falls from the sustain discharge voltage Vs to a falling minimum voltage Vnf are applied to scan electrodes Y1 through Yn, and a bias voltage Vb is applied to sustain electrodes X1 through Xn after the reset falling pulse is applied. The application of the reset rising pulse and the reset falling pulse results in accumulating and erasing wall charges in and from discharge cells and performing a weak discharge so that all the discharge cells are initialized.

In an address period PA, a scan pulse sequentially having a high level Vsch and a low level Vscl is applied to the scan electrodes Y1 through Yn, and a display data signal having a high level Va is applied to address electrodes Al through Am in accordance with the scan pulse so that an address discharge is performed.

In a sustain period PS, a sustain pulse alternately having a high level Vs and a low level Vg is applied to the scan electrodes Y1 through Yn and the sustain electrodes X1 through Xn so that a sustain discharge is performed in a discharge cell where the address discharge is performed, i.e., those discharge cells selected to be turned on.

Plasma display panels use a discharge gas mixture of Ne, Xe, etc., particularly, having a high partial pressure of Xe, to realize high brightness and contrast. To this end, plasma display panels must use a high discharge voltage.

However, the conventional plasma display panel experiences a discharge failure, more specifically, an erroneous discharge caused by the high discharge voltage necessary in order to use the discharge gas having the high partial pressure of Xe to realize high brightness and contrast.

FIGS. 7A and 7B illustrate the state of wall charges accumulated in the discharge cells after the reset rising pulse and the reset falling pulse are applied in FIG. 1. Referring to FIG. 7A showing one discharge cell, after the reset rising pulse is applied to the scan electrodes Y1 through Yn, negative wall charges are accumulated around the scan electrode, and positive wall charges are accumulated around the sustain electrode and the address electrode so that a weak reset discharge is performed. However, after the reset falling pulse is applied to the scan electrodes Y1 through Yn, a difference between an electric potential of the sustain electrode and the scan electrode increases so that a strong reset discharge is performed between the sustain electrode and the scan electrode. Referring to FIG. 7B, the strong discharge prevents the wall charges accumulated between the sustain electrode and the scan electrode from being erased so that positive wall charges are accumulated around the address electrode, and negative wall charges are accumulated around the sustain electrode. In this regard, the sustain discharge occurs, i.e., the erroneous discharge occurs, in a discharge cell that is not addressed in the address period PA, i.e., the discharge cell where the address discharge is not performed.

### SUMMARY OF THE INVENTION

Aspects of the present invention provide a method of driving a plasma display panel having high brightness and high contrast which does not generate an erroneous discharge in a sustain period due to a strong discharge in a reset period.

According to an aspect of the present invention, there is provided a method of driving a plasma display panel in which discharge cells are defined in areas where a plurality of electrodes cross, a unit frame used to express an image is divided into a plurality of sub fields, and each sub field is divided into a reset period where all discharge cells are initialized, an address period where a discharge cell from all the discharge cells is selected to be turned on and off, and a sustain period where a sustain discharge is performed in discharge cells that are selected to be turned on according to a gradation allocated to each of the sub fields, wherein, in the reset period, the reset falling pulse is applied to first electrodes among the plurality of electrodes, a bias voltage is applied to second electrodes parallel to the first electrodes from when the reset falling pulse is applied, and the second electrodes are floated during a predetermine period from when the reset falling pulse is applied to when the reset period ends.

While not required in all aspects, the bias voltage may be applied to the second electrodes during a first period from when the reset falling pulse is applied, and the second electrodes may be floated during a second period from the first period to when the reset period ends.

According to an aspect of the present invention, there is provided a method of driving a plasma display panel in which discharge cells are defined in areas where a plurality of electrodes cross, a unit frame used to express an image is divided into a plurality of sub fields, and each sub field is divided into a reset period where all discharge cells are initialized, an address period where a discharge cell is selected from all the discharge cells to be turned on and off, and a sustain period where a sustain discharge is performed in discharge cells that are selected to be turned on according to a gradation allocated to each of the sub fields, wherein, in the reset period, the reset falling pulse is applied to first electrodes among the plurality of electrodes, a bias voltage is applied to second electrodes parallel to the first electrodes from when the reset falling pulse is applied, and a bias falling pulse is applied to the second electrodes during a predetermine period from when the reset falling pulse is applied to when the reset period ends.

While not required in all aspects, the bias voltage may be applied to the second electrodes during a third period from when the reset falling pulse is applied, and the bias falling pulse may be applied to the second electrodes during a fourth period from the third period to when the reset period ends.

While not required in all aspects, in the address period, a scan pulse sequentially having a high level and a low level may be applied to the first electrodes, a display data signal having a high level may be applied to third electrodes crossing the first and second electrodes in accordance with the scan pulse, and the bias voltage may be applied to the second electrodes.

While not required in all aspects, in the sustain period, a sustain pulse having a high level and a low level may be alternately applied to the first and second electrodes.

While not required in all aspects, a reset rising pulse may be applied to the first electrodes before the reset falling pulse is applied in a reset period of a first sub field among the plurality of sub fields.

While not required in all aspects, portions of the method can be implemented using computer software and/or firmware encoded on one or more computer readable media to be implemented on one or more computers.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates waveforms of a driving signal for driving a conventional plasma display panel;

FIG. 2 illustrates an arrangement of electrodes of a plasma display panel to which a method of driving the plasma display panel is applied according to an embodiment of the present invention;

FIG. 3 is a timing diagram for explaining an address display separation (ADS) method according to an embodiment of the present invention;

FIG. 4 is a block diagram of a plasma display device to which the method of driving the plasma display panel is applied according to an embodiment of the present invention;

FIG. 5 is a timing diagram of a driving signal used to drive a plasma display panel according to an embodiment of the present invention;

FIG. 6 is a timing diagram of a driving signal used to drive a plasma display panel according to another embodiment of the present invention;

FIG. 7A illustrates wall charges accumulated in a discharge cell after the reset rising pulse is applied in FIGS. 1, 5, and 6;

FIG. 7B illustrates wall charges accumulated in a discharge cell after the reset falling pulse is applied in FIG. 1; and

FIG. 7C illustrates wall charges accumulated in a discharge cell after the reset falling pulse is applied in FIG. 5 or 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

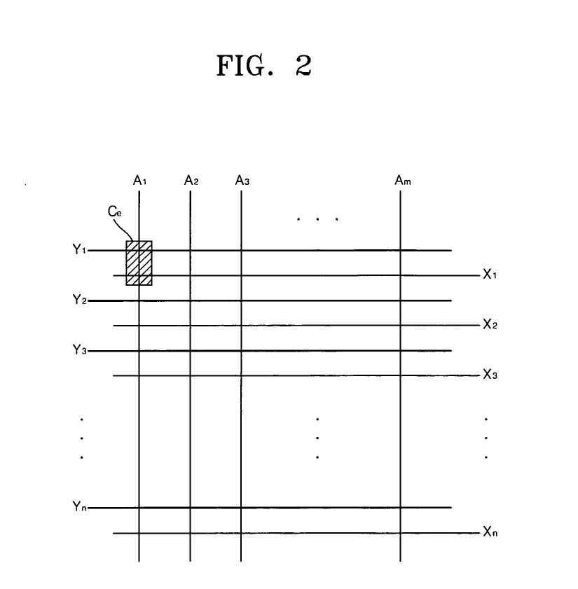

FIG. 2 illustrates an arrangement of electrodes of a plasma display panel to which a method of driving the plasma display panel is applied according to an embodiment of the present invention.

Referring to FIG. 2, first electrodes (scan electrodes Y1 through Yn) and second electrodes (sustain electrodes X1 through Xn) are parallel to each other, and third electrodes (address electrodes A1 through Am) cross the first electrodes (scan electrodes Y1 through Yn) and the second electrodes (sustain electrodes X1 through Xn). Discharge cells are defined in an area where the first and the second electrodes cross the third electrodes Ce.

Although the current embodiment of the present invention is applied to a 3-electrode type plasma display panel, the method of driving the plasma display panel according to aspects of the present invention can be applied to a 2-electrode type plasma display panel. The 3-electrode type plasma display panel will be described hereinafter.

The 3-electrode type plasma display panel generally comprises first and second substrates, a plurality of electrodes that cross one another between the first and second substrates, barrier ribs that partition discharge cells which are discharge spaces at areas where the plurality of electrodes cross one another, phosphor layers arranged in the discharge cells, and a discharge gas.

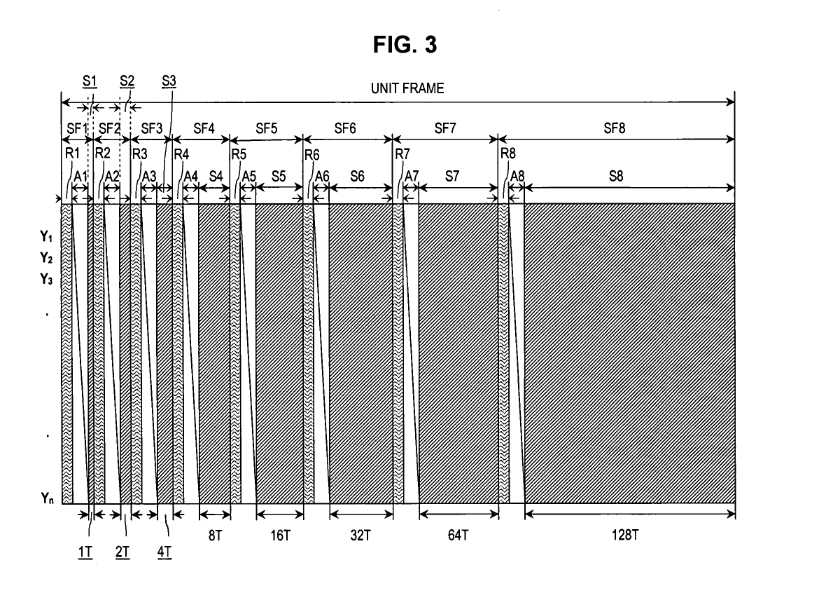

FIG. 3 is a timing diagram for explaining an address display separation (ADS) method.

Referring to FIG. 3, a unit frame used to express an image is divided into a plurality of sub fields SF and each sub field SF is divided into a reset period R, an address period A, and a sustain-discharge period S. In the reset period R, all discharge cells are initialized. In the address period A, a discharge cell is selected to be turned on and off from all the discharge cells. In the sustain discharge period S, a sustain discharge is performed in discharge cells that are selected to be turned on according to a gradation allocated to each of the sub fields SF. The time division driving method that applies a signal according to the reset, address, and sustain periods is used to drive a plasma display panel.

In the current embodiment of the present invention, the unit frame is divided into the 8 sub-fields SF1 through SF8, each of the sub-fields SF1 through SF8 is divided into a reset period R1 through R8, an address period Al through A8, and a sustain discharge period S1 through S8, respectively, and gradations of each of the sub-fields are allocated as 1, 2, 4, 8,16, 32, 64, and 128, but the present invention is not limited thereto. That is, the number of the sub-fields can be more or less than 8, and the allocation of the gradations can be modified according to a design.

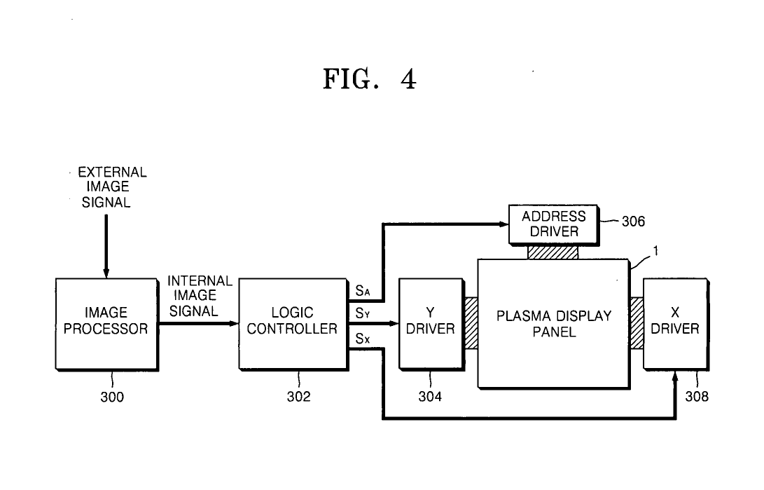

FIG. 4 is a block diagram of a plasma display device to which the method of driving the plasma display panel is applied according to an embodiment of the present invention.

Referring to FIG. 4, the plasma display device includes an image processor 300, a logic controller 302, a Y driver 304, an address driver 306, an X driver 308, and a plasma display panel 1.

The image processor 300 converts an external analog image signal such as a computer (PC) signal, a DVD signal, a video signal, a TV signal, etc., into a digital signal, image-processes the converted digital signal, and generates an internal image signal. The internal image signal includes red (R), green (G), and blue (B) image data, a clock signal, and vertical and horizontal synchronization signals.

The logic controller 302 receives the internal image signal from the image processor 300 and generates a Y driver control signal SY, an address driver control signal SA, and an X driver control signal SX by processing a gamma correction and an automatic power control (APC) for the internal image signal received from the image processor 300.

The Y driver 304, the address driver 306, and the X driver 308 respectively receive the Y driver control signal SY, the address driver control signal SA, and the X driver control signal SX from the logic controller 302, and apply them to first electrodes (scan electrodes), third electrodes (address electrodes), and second electrodes (sustain electrodes), respectively, of the plasma display panel 1.

The Y driver 304 applies reset pulses to the scan electrodes Y1 through Yn in a reset period. While not required in all aspects, the reset pulses may include only reset falling pulses, or reset rising pulses and reset falling pulses. Wall charges are accumulated in, or erased from, discharge cells due to the reset pulses so that the discharge cells are initialized. The Y driver 304 applies synchronized scan pulses sequentially having a high level and a low level to the scan electrodes Y1 through Yn in an address period. The Y driver 304 applies synchronized sustain pulses having a high level and a low level to the scan electrodes Y1 through Yn in a sustain period.

The address driver 306 applies display data signals having a high level in accordance with the scan pulses in the address period. Address discharges are performed in the address period due to the display data signals and the scan pulses.

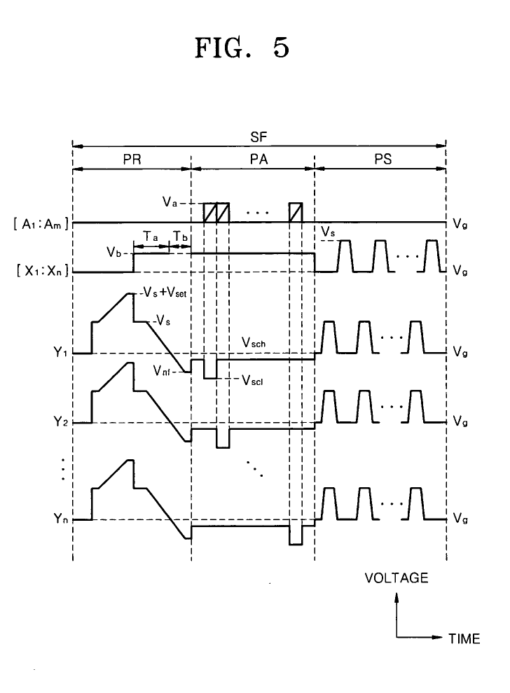

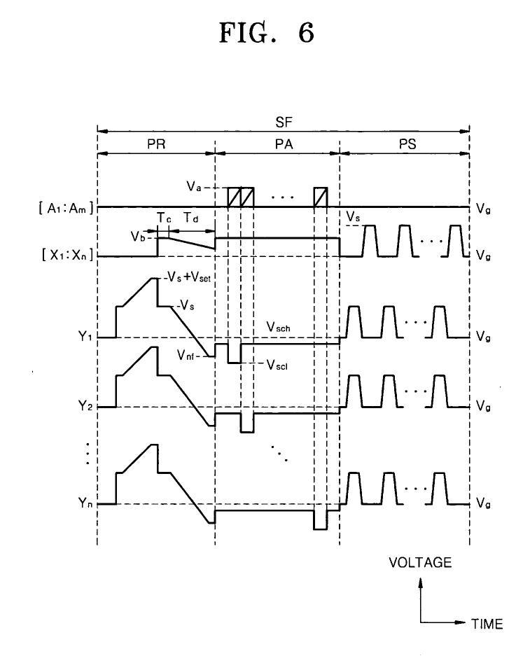

The X driver 308 applies a bias voltage in the reset period and the address period, and the sustain pulses in the sustain period. The bias voltage is applied after the reset falling pulse is applied, and the sustain electrodes are floated (refer to FIG. 5) or bias falling pulses are applied to the sustain electrodes (refer to FIG. 6) in a predetermined period from when the reset falling pulses are applied to when the reset period ends.

FIG. 5 is a timing diagram of a driving signal used to drive a plasma display panel according to an embodiment of the present invention.

Referring to FIG. 5, in the reset period PR, reset pulses including reset rising pulses and reset falling pulses are applied to the scan electrodes Y1 through Yn, a bias voltage Vb is applied to the sustain electrodes X1 through Xn during a first period Ta from when the reset falling pulses are applied, and the sustain electrodes X1 through Xn are floated during a second period Tb from the first period Ta to the end of the reset period PR.

In the address period PA, scan pulses sequentially having a high level Vsch and a low level Vscl are applied to the scan electrodes Y1 through Yn, display data signals having a high level Va are applied to the address electrodes A1 through Am in accordance with the scan pulses, and the bias voltage Vb is applied to the sustain electrodes X1 through Xn.

In the sustain period PS, sustain pulses having a high level Vs and a low level Vg are alternately applied to the sustain electrodes X1 through Xn and the scan electrodes Y1 through Yn.

FIG. 6 is a timing diagram of a driving signal used to drive a plasma display panel according to another embodiment of the present invention.

Referring to FIG. 6, in the reset period PR, reset pulses including reset rising pulses and reset falling pulses are applied to the scan electrodes Y1 through Yn, a bias voltage Vb is applied to the sustain electrodes X1 through Xn during a third period Tc from when the reset falling pulses are applied, and bias falling pulses are applied to the sustain electrodes X1 through Xn during a fourth period Td from the third period Tc to the end of the reset period PR.

In the address period PA, scan pulses sequentially having a high level Vsch and a low level Vscl are applied to the scan electrodes Y1 through Yn, display data signals having a high level Va are applied to the address electrodes A1 through Am in accordance with the scan pulses, and the bias voltage Vb is applied to the sustain electrodes X1 through Xn.

In the sustain period PS, sustain pulses having a high level Vs and a low level Vg are alternately applied to the sustain electrodes X1 through Xn and the scan electrodes Y1 through Yn.

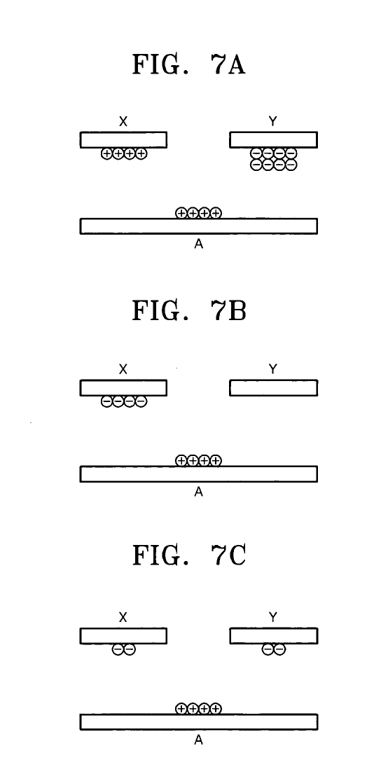

The state of wall charges accumulated in discharge cells using the driving methods illustrated in FIGS. 5 and 6 will now be described with reference to FIGS. 7A through 7C.

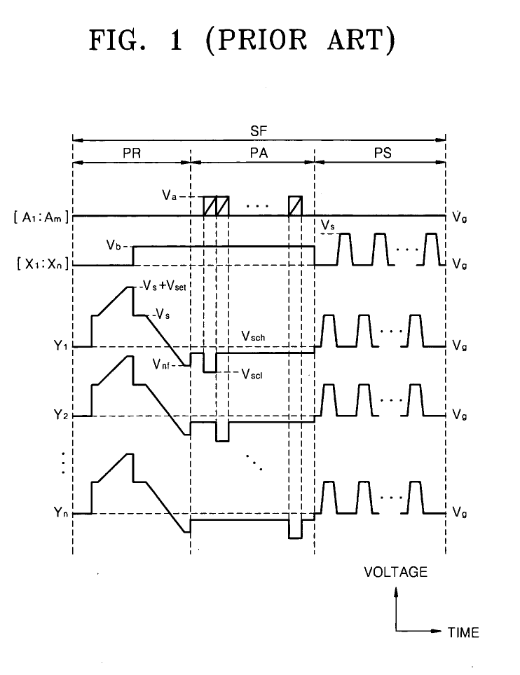

FIG. 7A illustrates wall charges accumulated in a discharge cell after the reset rising pulse is applied in FIGS. 1, 5, and 6, FIG. 7B illustrates wall charges accumulated in a discharge cell after the reset falling pulse is applied in FIG. 1, and FIG. 7C illustrates wall charges accumulated in a discharge cell after the reset falling pulse is applied in FIG. 5 or 6.

When the reset rising pulses are applied to the scan electrodes Y1 through Yn in the reset period PR in FIGS. 5 and 6, referring to FIG. 7A, in each discharge cell negative wall charges are accumulated around a scan electrode Y, and positive wall charges are accumulated around an address electrode A and a sustain electrode X, so that a weak discharge is performed.

After the reset rising pulses are applied, the reset falling pulses are applied to the scan electrodes Y1 through Yn, and the bias voltage Vb is applied to the sustain electrodes X1 through Xn, the sustain electrodes X1 through Xn are floated as illustrated in FIG. 5, or the bias falling pulses are applied to the sustain electrodes X1 through Xn as illustrated in FIG. 6. In this case, referring to FIG. 7C, in each discharge cell positive wall charges are accumulated around an address electrode A, and a small quantity of negative wall charges are accumulated around the sustain electrode X and the scan electrode Y Because the bias voltage Vb applied to the sustain electrodes X1 through Xn reduces an electric potential by floating the sustain electrodes X1 through Xn, or applying the bias falling pulses to the sustain electrodes X1 through Xn, which weakens a discharge generated between each sustain electrode X and each scan electrode Y, the wall charges are properly erased from each such discharge cell.

On the other hand, if the driving method illustrated in FIG. 1 is applied to a plasma display panel using a discharge gas having a high partial pressure of Xe gas, when the reset falling pulses are applied to the scan electrodes Y1 through Yn, and the bias voltage Vb is applied to the sustain electrodes X1 through Xn, an electric potential in each discharge cell between the sustain electrode X and the scan electrode Y is increased, which generates a strong discharge between the sustain electrode X and the scan electrode Y. In this case, referring to FIG. 7B, positive wall charges are accumulated around the address electrode A, and negative wall charges are accumulated around the sustain electrode X. The state of the wall charges causes an undesired sustain discharge (an erroneous discharge) during the sustain period PS in a discharge cell that is not selected to be turned on in the address period PA. Therefore, the driving method illustrated in FIGS. 5 and 6 can remove the problem of FIG. 7B.

Referring to FIGS. 5 and 6, the state of the wall charges illustrated in FIG. 7C is formed when the reset period PR terminates, and address discharges are performed in the discharge cells selected to be turned on using the scan pulses and the display data signals in the address period PA. In each discharge cell where the address discharge is performed, negative wall charges are accumulated around the sustain electrode X, and positive wall charges are accumulated around the scan electrode Y. The state of the wall charges illustrated in FIG. 7C is formed in each discharge cell where the address discharge is not performed.

Referring to FIGS. 5 and 6, the sustain pulses are alternately applied to the scan electrodes Y1 through Yn and the sustain electrodes X1 through Xn in the sustain period PS, so that a sustain discharge is performed in each discharge cell selected to be turned on in the address period PA. In detail, such a sustain discharge is performed by the state of the wall charges in the address period PA and the sustain pulse having the high level Vs and the low level Vg. The state of the wall charges illustrated in FIG. 7C is formed in each discharge cell that is not selected to be turned on in the address period PA. Therefore, although the sustain pulse having the high level Vs and the low level Vg is applied, the sustain discharge is not performed, thereby generating no erroneous discharge.

FIGS. 5 and 6 illustrate the reset pulses as the reset rising pulses and the reset falling pulses in the reset period PR but the present invention is not limited thereto. For example, the reset pulses can include only the rest falling pulses. Aspects of the present invention can be applied to a selective reset driving method.

The selective reset driving method applies the reset rising pulses and the reset falling pulses to the scan electrodes Y1 through Yn in the reset period PR of a predetermined sub-field, and the reset falling pulses are applied to the scan electrodes Y1 through Yn in the reset period PR of sub-fields excluding the predetermined sub-field. In detail, when the reset rising pulses and the reset falling pulses are applied, all discharge cells are initialized. When the reset falling pulses are applied, each discharge cell where the sustain discharge is performed in the sustain period PS of a previous sub-field is initialized.

When the reset falling pulses are applied, the sustain electrodes X1 through Xn are floated for a predetermined period or the bias falling pulses are applied to the sustain electrodes X1 through Xn in order to reduce the electric potential of the bias voltage Vb applied to the sustain electrodes X1 through Xn. Therefore, the selective reset driving method can be applied using an embodiment of the present invention.

A bias voltage is applied to sustain electrodes from when reset falling pulses are applied in a reset period, and then the sustain electrodes are floated during a predetermined period from when the reset falling pulses are applied to when the reset period ends, or bias falling pulses are applied to the sustain electrodes, so that weak reset discharges between the sustain electrodes and scan electrodes are performed in each discharge cell. Such weak reset discharges are effective in a plasma display panel having high brightness and high partial pressure of Xe gas, thereby generating no strong discharges between the sustain electrodes and scan electrodes in the reset period, and no erroneous discharges in a sustain period. That is, the plasma display panel performs a stable discharge.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of driving a plasma display panel in which discharge cells are defined in areas where a plurality of electrodes cross, a unit frame used to express an image is divided into a plurality of sub fields, and each sub field is divided into a reset period where all discharge cells are initialized, an address period where a discharge cell is selected to be turned on and off from all the discharge cells, and a sustain period where a sustain discharge is performed in discharge cells that are selected to be turned on according to a gradation allocated to each of the sub fields, the method comprising:
in the reset period, applying reset falling pulses to first electrodes among the plurality of electrodes, applying a bias voltage to second electrodes parallel to the first electrodes from when the reset falling pulses are applied, and floating the second electrodes during a predetermined period from when the reset falling pulses are applied to when the reset period ends.

2. The method of claim 1, wherein the bias voltage is applied to the second electrodes during a first period from when the reset falling pulses are applied, and the second electrodes are floated during a second period from an end of the first period to when the reset period ends.

3. The method of claim 1, further comprising:
in the address period, applying scan pulses sequentially having a high level and a low level to the first electrodes, applying display data signals having a high level to third electrodes crossing the first and second electrodes in accordance with the scan pulses, and applying the bias voltage to the second electrodes.

4. The method of claim 1, further comprising:
in the sustain period, alternately applying sustain pulses having a high level and a low level to the first and second electrodes.

5. The method of claim 1, further comprising applying reset rising pulses to the first electrodes before the reset falling pulses are applied in a reset period of a first sub field among the plurality of sub fields.

6. A method of driving a plasma display panel in which discharge cells are defined in areas where a plurality of electrodes cross, a unit frame used to express an image is divided into a plurality of sub fields, and each sub field is divided into a reset period where all discharge cells are initialized, an address period where a discharge cell is selected to be turned on and off from all the discharge cells, and a sustain period where a sustain discharge is performed in discharge cells that are selected to be turned on according to a gradation allocated to each of the sub fields, the method comprising:
in the reset period, applying reset falling pulses to first electrodes among the plurality of electrodes, applying a bias voltage to second electrodes parallel to the first electrodes from when the reset falling pulses are applied, and applying bias falling pulses to the second electrodes during a predetermined period from when the reset falling pulses are applied to when the reset period ends.

7. The method of claim 6, wherein the bias voltage is applied to the second electrodes during a third period from when the reset falling pulses are applied, and the bias falling pulses are applied to the second electrodes during a fourth period from an end of the third period to when the reset period ends.

8. The method of claim 6, wherein the bias voltage is applied to the second electrodes during a fifth period from when the reset falling pulses are applied, the second electrodes are floated during a sixth period from an end of the fifth period, and the bias falling pulses are applied to the second electrodes during a seventh period from an end of the sixth period to when the reset period ends.

9. The method of claim 6, wherein the bias voltage is applied to the second electrodes during the fifth period from when the reset falling pulses are applied, the bias falling pulses are applied to the second electrodes during a sixth period from an end of the fifth period, and the second electrodes are floated during a seventh period from an end of the sixth period to when the reset period ends.

10. The method of claim 6, further comprising:
in the address period, applying scan pulses sequentially having a high level and a low level to the first electrodes, applying display data signals having a high level to third electrodes crossing the first and second electrodes in accordance with the scan pulses, and applying the bias voltage to the second electrodes.

11. The method of claim 6, further comprising:
in the sustain period, alternately applying sustain pulses having a high level and a low level to the first and second electrodes.

12. The method of claim 6, further comprising applying reset rising pulses to the first electrodes before the reset falling pulses are applied in a reset period of a first sub field among the plurality of sub fields.

13. A method of resetting a plasma discharge cell, comprising:
applying a falling pulse to first electrodes among a plurality of electrodes during a reset period;
applying a bias voltage to second electrodes parallel to the first electrodes from when the falling pulse is applied; and
floating the second electrodes during a predetermined period from when the bias voltage is applied to when the reset period ends.

14. A method of resetting a plasma discharge cell comprising:
applying a falling pulse to first electrodes among a plurality of electrodes during a reset period;
applying a bias voltage to second electrodes parallel to the first electrodes from when the falling pulse is applied; and
applying a bias falling pulse to the second electrodes during a predetermined period from when the reset falling pulse is applied to when the reset period ends.

15. A plasma display device comprising:
an image processor to convert an external analog image signal into a digital internal image signal;
a logic controller to receive the internal image signal from the image processor and generate a Y driver control signal, an address driver control signal, and an X driver control signal;
a Y driver to receive the Y driver control signal from the logic controller and apply it to first electrodes;
an X driver to receive the X driver control signal from the logic controller and apply it to second electrodes;
an address driver to receive the address driver control signal from the logic controller and apply it to third electrodes; and
a plasma display panel to display an image having the first electrodes and second electrodes parallel to each other, and the third electrodes cross the first electrodes and the second electrodes to define discharge cells;
wherein,
in a reset period, reset falling pulses are applied to the first electrodes, a bias voltage is applied to the second electrodes during a first period from when the reset falling pulses are applied, and the second electrodes are one of floated and biased with falling bias pulses during a second period from an end of the first period to an end of the reset period.
